(19) United States
(12) Patent Application Publication
(10) Pub. No.: US 2023/0306447 A1
(43) Pub. Date: Sep. 28, 2023

(54) METHOD AND SYSTEM FOR CONTEXTUAL SENTIMENT ANALYSIS OF COMPETITOR REFERENCED TEXTS

(71) Applicant: INFOSYS LIMITED, Bangalore (IN)

(72) Inventors: Romi MALIK, Punjab (IN); Debamalya CHOUDHURY, Bangalore (IN); Anshuman SHAROTRI, Pathankot (IN); Prasad R S, Bangalore (IN); Vinay Govindan MURALIDHARAN, Bangalore (IN); Kanad BHOWMIK, Kolkata (IN); Rashmikant MOHANTY, Bargarh (IN); Bhagyashree Mathad S, Dharwad (IN)

(21) Appl. No.: 17/704,939

(22) Filed: Mar. 25, 2022

(30) Foreign Application Priority Data
Mar. 24, 2022 (IN) 202241016600

(51) Int. Cl. G06Q 30/02; G06F 40/30; G06F 40/279

(52) U.S. Cl. CPC G06Q 30/0201; G06Q 30/0282; G06F 40/30; G06F 40/279

(57) ABSTRACT

Disclosed herein is method and system for contextual sentiment analysis of competitor referenced texts. The method comprises obtaining, by a system a plurality of texts and a lexicon comprising keywords indicating a competitor entity and a target entity. Further, identifying texts from the plurality of texts including the keywords. Furthermore, determining a pattern from a plurality of patterns in the texts using Artificial Intelligence (AI) models. Furthermore, identifying a placement of the competitor entity and the target entity in the texts using the AI models. Furthermore, determining for each of the texts, a tonality score indicating a tone towards the target entity based on the placement of the target entity and the pattern. Furthermore, determining a sentiment for each of the texts based on the tonality score. Finally, notifying the sentiment towards the target entity on a notification unit.

This application claims the benefit of Indian Patent Application No. 202241016600, filed Mar. 24, 2022, which is incorporated by reference in its entirety.

### FIELD

The present disclosure relates in general to sentiment analysis. Particularly, but not exclusively, the present disclosure relates to method and system for contextual sentiment analysis of competitor referenced texts.

### BACKGROUND

Sentiment analysis is the study or analysis of people sentiments towards products, offerings and services. Customers and social media users generally share their opinion about products and services on social media platforms via comments. Opinions, perspectives, and ideas are typically expressed through emoticons and alphanumeric content included in the comments. Customers' opinions or reviews about services and products are important to marketing teams for devising business strategies. Business teams constantly analyze customers sentiments (positive, negative, and neutral) to refine their strategies towards brand messaging, product and service development, customer retention and the like. Hence, analysis of customers sentiments is necessary, and computer-based analysis helps in analyzing large data set.

Existing systems are not accurate in determining the sentiment of the multi-competitor referenced texts which consists of multiple sentiments in each text. Existing systems are relatively broad in finding multi-competitor texts neglecting brand specific comments. As a result, the tonalities derived by such systems cannot be used by business teams. Furthermore, there are no reliable sentiment prediction techniques for quantifying the sentiment of a specific target brand in relation to multi-competitor reference texts as they neglect the context of the target and competitors. Hence, the sentiments derived using the conventional systems are not useful to determine the correct sentiments.

The information disclosed in this background of the disclosure section is only for enhancement of understanding of the general background of the invention and should not be taken as an acknowledgment or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

Disclosed herein is a method for contextual sentiment analysis of competitor referenced texts. The method comprises obtaining a plurality of texts and a lexicon comprising one or more keywords indicating at least one competitor entity and at least one target entity. Further, identifying one or more texts from the plurality of texts including the one or more keywords. Furthermore, determining a pattern from a plurality of patterns in the one or more texts using one or more Artificial Intelligence (AI) models, wherein the pattern includes one or more words in the one or more texts. Furthermore, identifying a placement of the at least one competitor entity and the at least one target entity in the one or more texts using the one or more AI models. Furthermore, determining for each of the one or more texts, a tonality score indicating a tone towards the at least one target entity based on the placement of the at least one target entity and the pattern. Furthermore, determining a sentiment for each of the one or more texts based on the tonality score. Finally, notifying the sentiment towards the at least one target entity on a notification unit.

In an embodiment, the present disclosure discloses a system for contextual sentiment analysis of competitor referenced texts, the system comprising: a processor and a memory. The processor is configured to obtain a plurality of texts and a lexicon comprising one or more keywords indicating at least one competitor entity and at least one target entity. Further, the processor is configured to identify one or more texts from the plurality of texts including the one or more keywords. Furthermore, the processor is configured to determine a pattern from a plurality of patterns in the one or more texts using one or more Artificial Intelligence (AI) models, wherein the pattern includes one or more words in the one or more texts. Furthermore, the processor is configured to identify a placement of the at least one competitor entity and the at least one target entity in the one or more texts using the one or more AI models. Furthermore, the processor is configured to determine for each of the one or more texts, a tonality score indicating a tone towards the at least one target entity based on the placement of the at least one target entity and the pattern. Furthermore, the processor is configured to determine a sentiment for each of the one or more texts based on the tonality score. Finally, notifying the sentiment towards the at least one target entity on a notification unit.

In an embodiment, the present disclosure discloses a non-transitory computer readable medium for contextual sentiment analysis of competitor referenced texts, having stored thereon, one or more instructions that when processed by at least one processor cause a device to perform operations comprising obtaining a plurality of texts and a lexicon comprising one or more keywords indicating at least one competitor entity and at least one target entity. Further, the processor is configured to identify one or more texts from the plurality of texts including the one or more keywords. Furthermore, the processor is configured to determine a pattern from a plurality of patterns in the one or more texts using one or more Artificial Intelligence (AI) models. The pattern includes one or more words in the one or more texts. Furthermore, the processor is configured to identify a placement of the at least one competitor entity and the at least one target entity in the one or more texts using the one or more AI models. Furthermore, the processor is configured to determine for each of the one or more texts, a tonality score indicating a tone towards the at least one target entity based on the placement of the at least one target entity and the pattern. Furthermore, the processor is configured to determine a sentiment for each of the one or more texts based on the tonality score. Finally, notifying the sentiment towards the at least one target entity on a notification unit.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an environment illustrating contextual sentiment analysis of competitor referenced texts, in accordance with some embodiments of the present disclosure;

FIG. 2 shows a detailed block diagram of system for contextual sentiment analysis of competitor referenced texts, in accordance with some embodiments of the present disclosure;

FIG. 3 shows a flowchart illustrating method steps for contextual sentiment analysis of competitor referenced texts, in accordance with some embodiments of the present disclosure;

FIG. 4 shows a flowchart illustrating method steps for determining patterns in the one or more texts using Artificial Intelligence (AI) models, in accordance with some embodiments of the present disclosure;

FIG. 5 shows a flowchart illustrating method steps for configuring one or more AI models, in accordance with some embodiments of the present disclosure;

FIG. 6 shows a flowchart illustrating method steps for determining a sentiment for texts based on the tonality score, in accordance with some embodiments of the present disclosure;

FIG. 7 and FIG. 8 show exemplary competitor-referenced texts, in accordance with some embodiments of the present disclosure;

FIG. 9 illustrates an exemplary notification unit for notifying the sentiment, in accordance with some embodiments of the present disclosure;

FIG. 10 illustrates a pattern lexicon for positive sentiment related texts, in accordance with some embodiments of the present disclosure;

FIG. 11 illustrates a pattern lexicon for negative sentiment related texts, in accordance with some embodiments of the present disclosure;

FIG. 12 shows an exemplary table illustrating raw data having target entity, in accordance with some embodiments of the present disclosure;

FIG. 13 shows an exemplary table illustrating data pre-processing of texts, in accordance with some embodiments of the present disclosure;

FIG. 14 illustrates an exemplary table of competitor entity lexicon data for competitors, in accordance with some embodiments of the present disclosure;

FIG. 15 illustrates an exemplary table of consolidated data after data pre-processing of texts, in accordance with some embodiments of the present disclosure;

FIG. 16 illustrates an exemplary table of multi-competitor referenced texts identification and removal of non-competitor texts, in accordance with some embodiments of the present disclosure;

FIG. 17 illustrates an exemplary table of training data comprising labelled sentiment of multi-competitor referenced texts, in accordance with some embodiments of the present disclosure;

FIG. 18 illustrates an exemplary table of training data comprising pattern taxonomy of competitor referenced texts, in accordance with some embodiments of the present disclosure;

FIG. 19 illustrates an exemplary table of training data with multi-competitor referenced texts tagged with sentiment based on placement identification and pattern detection, in accordance with some embodiments of the present disclosure;

FIG. 20 illustrates an exemplary table of final training data comprising actual sentiment tagged texts based on the patterns and placements, in accordance with some embodiments of the present disclosure;

FIG. 21 illustrates an exemplary table of tonality score assignment for competitor referenced texts, in accordance with some embodiments of the present disclosure;

FIG. 22 depicts an exemplary table of sentiment and tonality score threshold range, in accordance with some embodiments of the present disclosure;

FIG. 23 illustrates an exemplary table of a sentiment output determined by AI models for alphanumeric content, in accordance with some embodiments of the present disclosure;

FIG. 24 A illustrates an exemplary table of sentiment output determined for competitor-referenced texts comprising single-emoticon, in accordance with some embodiments of the present disclosure;

FIG. 24B illustrates an exemplary table of sentiment output determined for competitor-referenced texts comprising multi-emoticons, in accordance with some embodiments of the present disclosure;

FIG. 25 illustrates an exemplary table of sentiment output for competitor-referenced texts having emoticons and alphanumeric content, in accordance with some embodiments of the present disclosure;

FIG. 26 illustrates an exemplary table of accuracy assessment for overall sentiment of competitor-referenced texts, in accordance with some embodiments of the present disclosure;

FIG. 27 depicts a block diagram of a general-purpose computer capable of contextual sentiment analysis of competitor referenced texts, in accordance with an embodiment of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes, which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relates to method and system for contextual sentiment analysis of competitor referenced texts. The system receives data containing texts posted on various social media platforms or company websites. The texts are identified based on the one or more keywords of competitor brand and target brand. The texts may include reviews or opinions about products and services offered by the companies. Further, a pattern of words in the texts is determined using Artificial Intelligence (AI) models. A placement of the competitor entity and the target entity in the texts is determined using the AI models. A tonality score is determined indicating a tone towards the target entity based on the placement of the target entity and the pattern. Furthermore, a sentiment is determined for each of the competitor referenced texts based on the tonality score. Thereafter, the sentiment is displayed in accordance with the target entity on a notification unit.

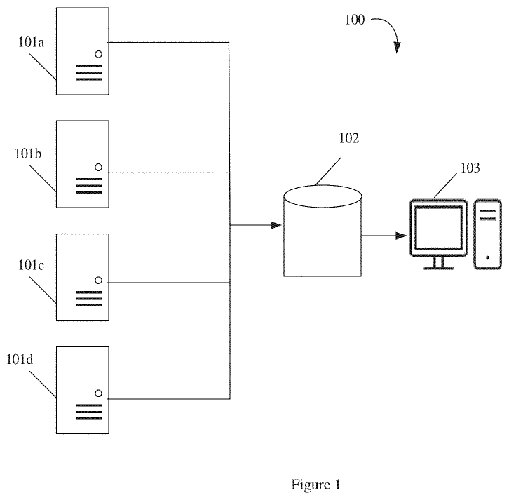

FIG. 1 shows a simplified environment (100) illustrating contextual sentiment analysis of competitor referenced texts. The environment (100) includes a plurality of data sources (101a, 101b, 101c, 101d) such as web servers, a database (102), a computing system (103). In an embodiment, the environment (100) may comprise plurality of data sources such as a data source 1 (101a), a data source 2 (101b), a data source 3 (101c), and a data source 4 (101d). Four data sources are disclosed in FIG. 1 only for illustrative purpose and it should not be considered as a limitation. There can be multiple data sources which can be indicated as data source 1 (101a) . . . data source n (101n). The plurality of data sources (101a, 101b, 101c, 101d) may be associated with different platforms comprising a plurality of texts. For example, the web server (101a) may be associated with a social media platform. Likewise, the web server (101a) may be associated with an online retailer. In such examples, customers may provide reviews or compare products or services of one brand with competitor brands. In an embodiment, texts are referred herein as comments, or reviews or articles or web pages or applications where feedback is provided for a product or services. One of the objectives of the present disclosure is to determine sentiment of customers towards at least one target entity in a text having name/reference of the at least one target entity and name/reference of at least one competitor entity. The plurality of data sources (101a, 101b, 101c, 101d) may hold data comprising the texts from a plurality of customers. In an embodiment, a text is also referred as comments, data, written opinions, product reviews and the like in the present disclosure.

In an embodiment, the computing system (103) receives the texts from the plurality of web servers (101a, 101b, 101c, 101d) and determines sentiment with regards to the target brand (at least one target entity). In one embodiment, the computing system (103) may directly receive the texts from the plurality of data sources (101a, 101b, 101c, 101d) via an Application Program Interface (API) call or the texts may be stored in the database (102), which may be optional, and the computing system may receive the texts from the database (102). Further, the computing system (103) may include a sentiment prediction module, which is configured to identify one or more texts from the plurality of texts including the name of the at least one target entity and name of the at least one competitor entity. In an embodiment, the sentiment prediction module is also referred as Artificial Intelligence (AI) models. Further, the sentiment prediction module determines a sentiment for each of the one or more texts. In an embodiment, the sentiment can be positive, negative or neutral. Finally, the sentiment towards the target entity is displayed on a notification unit (not shown in FIG. 1) associated with the computing system (103).

In one implementation, the computing system (103) may be realized in the customer environment or may be realized as a cloud server and may be configured as a Software as a Service (SaaS).

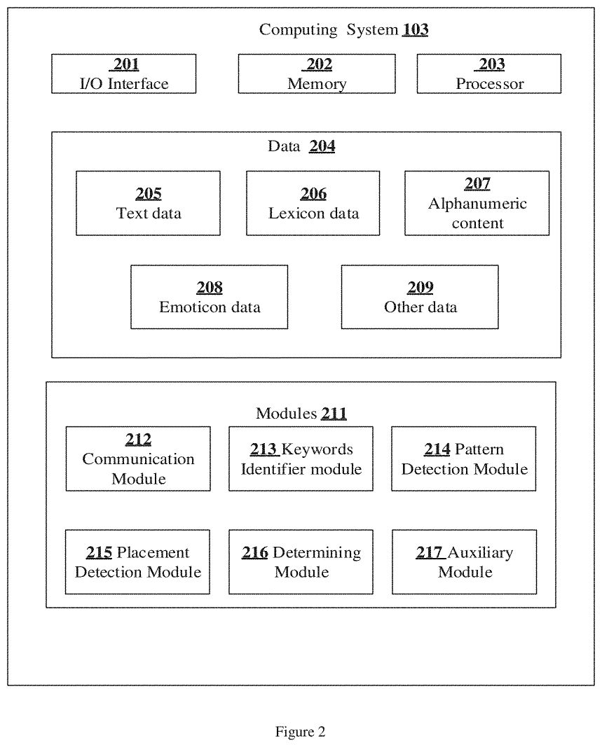

FIG. 2 shows a detailed block diagram of the computing system (103). The computing system (103) may include Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The computing system (103) further includes an Input/Output (I/O) interface (201). The I/O interface (201) may be coupled with the processor (203) through which an input signal or/and an output signal may be communicated.

In some embodiments, the computing system (103) comprises modules (211). The modules (211) may be stored within the memory (202). In an example, the modules (211) are communicatively coupled to the processor (203) and may also be present outside the memory (202) as shown in FIG. 2 and implemented as hardware. As used herein, the term modules (211) may refer to an application specific integrated circuit (ASIC), a Field Programmable Gate Array (FPGA), an electronic circuit, a processor (203) (shared, dedicated, or group), and memory (202) that execute one or more software or firmware programs, a combinational logic circuit, and/or other suitable components that provides the described functionality. In some other embodiments, the modules (211) may be implemented using at least one of ASICs and FPGAs.

In an embodiment, an Input/Output (I/O) interface (201) may enable communication between the computing system (103) and associated devices.

In one implementation, the data (204) may include, for example, text data (205), lexicon data (206), alphanumeric content (207), emoticon data (208) and other data (209). It may be appreciated that such aforementioned data (204) may be represented independently or a combination thereof.

In an embodiment, the text data (205) may comprise data related to texts obtained from plurality of data sources (101a, 101b, 101c, 101d). The text data (205) may comprise at least alphanumeric content, and emoticons. The alphanumeric content may represent the words of the customer providing a review/feedback/opinion about a product/service offered by the at least one target entity or the at least one competitor entity. In an embodiment, one or more names/references associated with the at least one target entity and the at least one competitor entity is provided as input or stored in the computing system (103). Below is an exemplary competitor-referenced text. “@X Y they are number 1 they have best coverage out of all carriers Z is 2^{nd} best coverage, X you need to gear up your service [symbol] ”. In the above example, “X” may be the target entity and “Y” and “Z” herein may be the competitor entities. “X Y they are number 1 they have best coverage out of all carriers Z is 2^{nd} best coverage “depicts a sentence commenting about the target entity and the competitor entities. The emoticons/symbols “ [symbol] ” further asserts an emotion of the customer. In the above example, the emotion towards the competitor “Y” and “Z” are positive and the emotion towards the target entity “X” is negative. The present disclosure describes how the emotion towards a particular entity (for example the target entity) is determined in a text comprising multiple emotions towards multiple entities.

In an embodiment, the lexicon data (206) may comprise one or more keywords indicating at least one competitor entity and at least one target entity. In an embodiment, the one or more keywords include abbreviations, full names, short names, social handle names, one or more representatives of the at least one target entity and the at least one competitor entity short names, full names, social handle names, abbreviations, chief experience officer (CXO) names and the like. For example, the company P-mobile is also referred as @Pmobile, @PMobileHelp, Pmobile, Pmodile, <P Mobile CEO Name>, Team Orange, PMob-Maybe and so on. Likewise. ZT&T is also referred as ZT&T, ZTT, @ZTT, ZTTCares, Ztnt, ZTTSupport, ZTTHelp. In addition, the lexicon data (206) may also comprise pattern lexicon. Pattern lexicon comprises one or more words in the texts, pattern type and pattern sub-type. For example, pattern type may include a pattern lexicon for positive sentiment related texts, negative sentiment related texts and neutral sentiment related texts.

In an embodiment, the alphanumeric content (207) may comprise alphabetical characters, words, sentences, numerical, punctuations, emoticons and the like. In the below example, “@X Y they are number 1 they have best coverage out of all carriers Z is 2^{nd} best coverage, X you need to gear up your service” indicates alphanumeric content data. Herein @, 2^{nd}, number 1 are the various contents included in the alphanumeric content. In one implementation, the alphanumeric content (207) may be extracted into separate file or may be temporarily stored in the memory (202) for processing the alphanumeric content (207).

In an embodiment, the emoticon data (208) may comprise emotional icons are used to transmit emotions. The emoticons may emphasize the emotions of the customers. In an embodiment, emotional icons are also referred as emoticons. Emoticons may be positive emotional icons, negative emotional icons and neutral emotional icons. Emoticons helps in determining sentiment of texts additional to the sentiments determined using alphanumeric content. In one implementation, the emoticon data may be extracted into separate file or may be temporarily stored in the memory (202) for processing the emoticon data (208).

In an embodiment, the other data (209) may comprise non-textual data like image data comprising customers opinions. The image data is processed using image processing techniques to extract text.

In one implementation, the modules (211) may include, for example, a communication module (212), a keywords identifier module (213), a pattern detection module (214), a placement detection module (215), determining module (216) and auxiliary module (217). It may be appreciated that such aforementioned modules (211) may be represented as a single module (211) or a combination of different modules (211).

In an embodiment the communication module (212) is configured to obtain a plurality of texts and a lexicon via the I/O interface (201). The communication module (212) may then store plurality of texts and a lexicon in the database (102) for further processing of texts. The communication module (212) further transmits the texts to other modules like the keywords identifier module (213) for further computation. The text data extraction may be performed using scraping web pages using open-source packages. For example, open-source python packages may be Scikit-learn, Pandas, NumPy, TensorFlow, Keras and the like.

In an embodiment, the keywords identifier module (213) is configured to identify one or more texts from the plurality of texts including the one or more keywords. The one or more keywords include abbreviations, full names, short names, social handle names, one or more representatives of the at least one target entity and the at least one competitor entity. In an embodiment, the keywords identifier module (213) may be configured to identify specific keywords. One or more names/references of the at least one target entity and one or more names/references of the at least one competitor entity may be provided to the keywords identifier module (213) for identifying the one or more keywords in the plurality of texts. The keywords identifier module (213) assists in searching the competitor referenced texts using the keywords. Competitor referenced texts should not be considered as a limitation referring only to the at least one competitor. It is an indication that texts having target brand and competitor brand are identified and such brand names are further identified. In an embodiment, the texts from the plurality of texts not comprising the one or more keywords may be rejected. Further, the keywords identifier module (213) provides the one or more texts to the pattern detection module (214).

In an embodiment, the pattern detection module (214) is configured to determine a pattern from a plurality of patterns in the one or more texts using one or more Artificial Intelligence (AI) models. In an embodiment, the pattern includes one or more ways in which words are present in the one or more texts. The plurality of patterns of words may have a same or similar semantic meaning. For example, <Competitor Brand> . . . move over to <Target Brand>, <Competitor Brand> . . . left for <Target Brand>. Herein “move over to” and “left for” are examples for pattern detection. These different patterns of words depict the same context. Further, the pattern detection module (214) may also determine a plurality of patterns of the at least one competitor entity and the at least one target entity in the one or more texts.

In an embodiment, the placement detection module (215) is configured to identify a placement of the at least one competitor entity and the at least one target entity in the one or more texts using the one or more AI models. For example, <Competitor Brand> . . . move over to <Target Brand>, <Competitor Brand> . . . left for <Target Brand>. Herein, “begin with competitor entity reference and end with target entity reference”, “begin with target entity reference and end with competitor entity reference”. In the above example, the placement of entities in the text is “begin with competitor entity reference and end with target entity reference”, Upon identifying the placement of the at least one competitor entity and the at least one target entity in the one or more texts, the determining module (216) determines a tonality score and a sentiment for each of the one or more texts based on the tonality score.

In an embodiment, the determining module (216) is configured to determine a tonality score indicating a tone towards the at least one target entity based on the placement of the at least one target entity and the detected pattern of words present in the one or more texts. In an embodiment, one or more threshold ranges are defined for the alphanumeric content-based tonality score, and a threshold range is defined for the emotional icons-based on tonality score.

In an embodiment, the determining module (216) is also configured to determine the sentiment for each of the one or more texts based on the tonality score. Determining the sentiment of the one or more texts comprises determining the sentiment based on alphanumeric content of the one or more texts, determining the sentiment based on emotional icons of the one or more texts and generating a composite sentiment based on the sentiment based on alphanumeric content and the sentiment based on emotional icons. The composite sentiment determines the sentiment of the one or more texts. The sentiment is one of, a negative sentiment, a positive sentiment, and a neutral sentiment. The sentiment based on alphanumeric content has higher priority over the sentiment of the emotional icons sentiment and the sentiment based on emotional icons has higher priority over the sentiment based on alphanumeric content when the sentiment based on alphanumeric content is a neutral sentiment.

Determining the sentiment for each of the plurality of training texts based on the tonality score generated and one or more threshold ranges. The one or more AI models are tuned, wherein tuning comprises comparing the sentiment determined by the one or more AI models with the sentiment tagged or labelled to the plurality of training texts. Determining the sentiment for the emotional icons comprises generating the tonality score for the emotional icon. Further, determining a maximum value of the tonality score and determining the sentiment based on the maximum value of the tonality score and the threshold range. Likewise, one or more threshold ranges are defined for the tonality score of the alphanumeric content. The sentiment for an input text is determined by comparing the determined tonality score of the text with the one or more threshold ranges. The composite sentiment is calculated using the sentiment determined for the alphanumeric content and the sentiment of the emoticons.

In an embodiment, the auxiliary module (217) may include a submodules like pre-processing submodule, a notification submodule or alert submodule. The pre-processing submodule may be used for processing the raw texts extracted from the plurality of data sources comprising one or more keywords indicating at least one competitor entity and at least one target entity. The pre-processing techniques used may be data cleaning or data transformation techniques. The one or more texts are cleansed with data cleaning techniques for removing duplicate comments. The notification submodule may notify the sentiment towards the at least one target entity on a notification unit. The notification submodule may indicate the sentiment with respect to target entity. If the sentiment is negative, then alert the target entity to improve their services or offerings or resolve customer concerns.

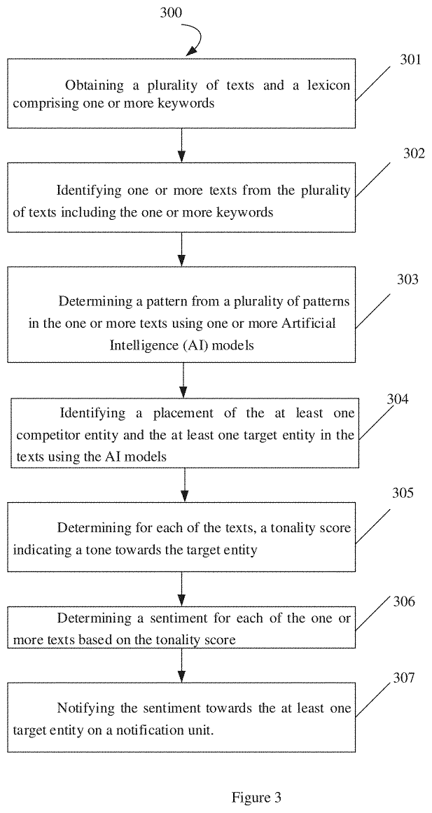

FIG. 3 shows a flowchart illustrating a method for contextual sentiment analysis of competitor referenced texts, in accordance with some embodiment of the present disclosure. The order in which the method (300) may be described is not intended to be construed as a limitation, and any number of the described method blocks may be combined in any order to implement the method. Additionally, individual blocks may be deleted from the methods without departing from the spirit and scope of the subject matter described herein. Furthermore, the method may be implemented in any suitable hardware, software, firmware, or combination thereof.

At the step (301), obtaining a plurality of texts and a lexicon from a plurality of servers comprising one or more keywords indicating at least one competitor entity and at least one target entity. In an embodiment, the plurality of texts is obtained from the plurality of data sources (101a, 101b, 101c, 101d). In an embodiment, texts are referred herein as comments, or reviews or articles or web pages or applications where feedback is provided for a product or services. The one or more keywords include abbreviations, full names, short names, social handle names, one or more representatives of the at least one target entity and the at least one competitor entity. In an embodiment, the plurality of texts and the lexicon can be extracted using application programming interface (APIs), scraping web pages using open-source packages, social media tools. and the like. The one or more texts may be stored in database (102).

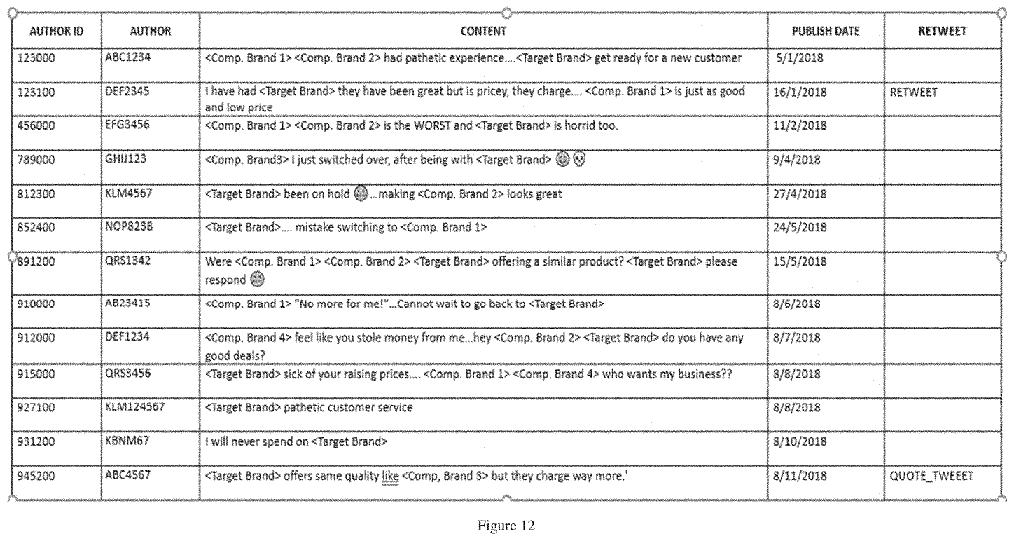

The one or more texts are processed using pre-processing techniques. The one or more texts are cleansed with cleansing techniques by removing duplicate comments (such as forwarding the comments/reviews, irrelevant contents such as news, offers, sales campaign and the like). In an embodiment, duplicate comments can be identified using unique IDs associated with each text from the plurality of texts or unique IDs associated with each customer commenting the plurality of texts. FIG. 12 shows an exemplary table illustrating raw data having target entity, in accordance with some embodiments of the present disclosure. The data pre-processing of texts may include the target entity specific raw texts before preprocessing. For example, as mentioned in the FIG. 12, the author ID can be 123000, author can be referred as ABC1234, Content may be “<Comp. Brand 1> <Comp. Brand 2> had pathetic experience . . . <Target Brand>” get ready for a new customer” and publish date can be May 1, 2018.

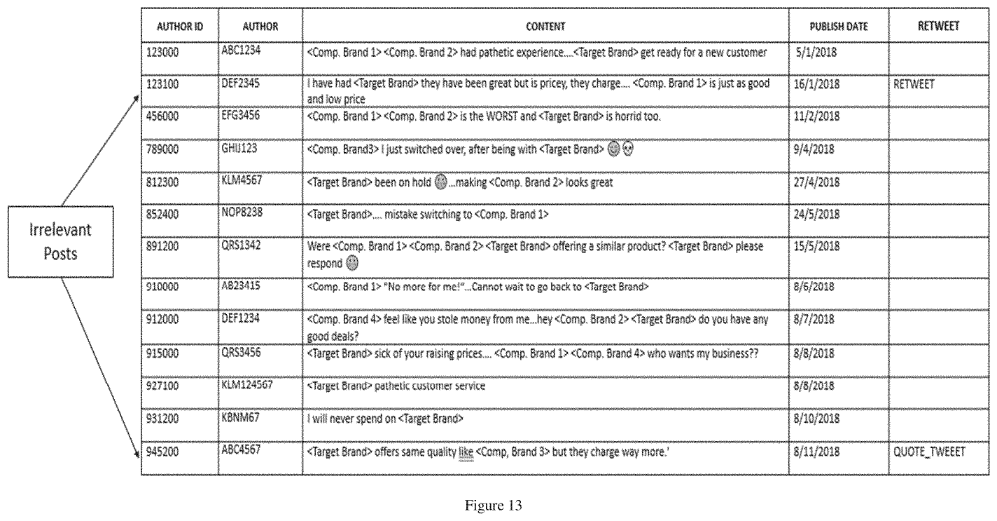

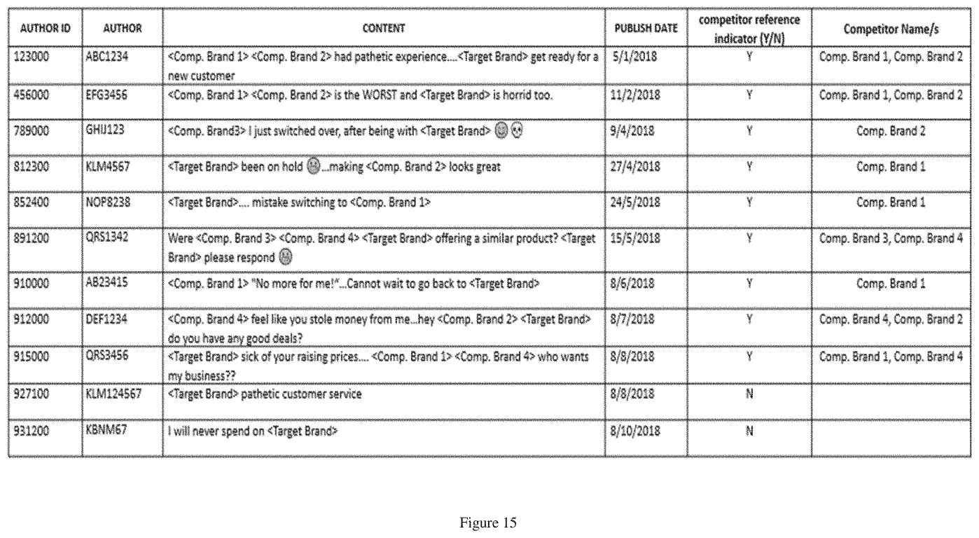

FIG. 13 shows an exemplary table illustrating data pre-processing of texts, in accordance with some embodiments of the present disclosure. Herein, the content with author ID 123100 is retweet and the content with author id 945200 is quote tweet which will be discarded during data cleansing or other data pre-processing methods. FIG. 15 illustrates an exemplary table of consolidated data after data pre-processing of texts, in accordance with some embodiments of the present disclosure. The consolidated data may comprise the consolidated texts after pre-processing of the one or more texts will be considered by removing the unwanted texts for further processing of one or more texts. In addition, the above example table contains, competitor reference indicator (Y/N), competitor name/s. For example, consider content “<Target Brand> . . . mistake switching to <Comp. Brand 1>“of author id-852400, author— NOP8238, publish date-24/5/2018, competitor reference indicator (Y/N) is Y, competitor name/s is <Comp. Brand 1>.

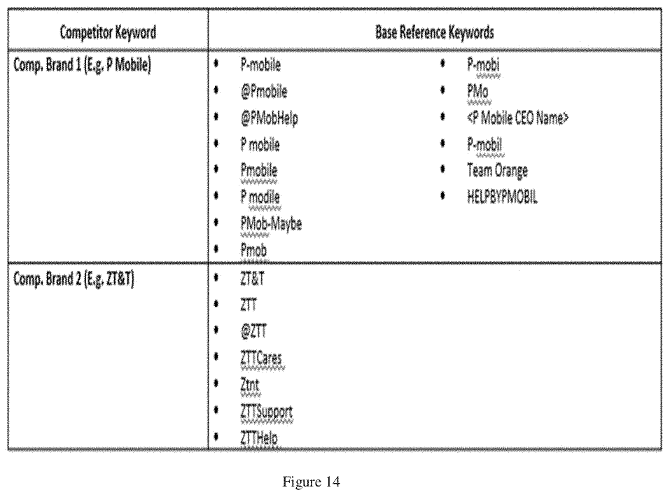

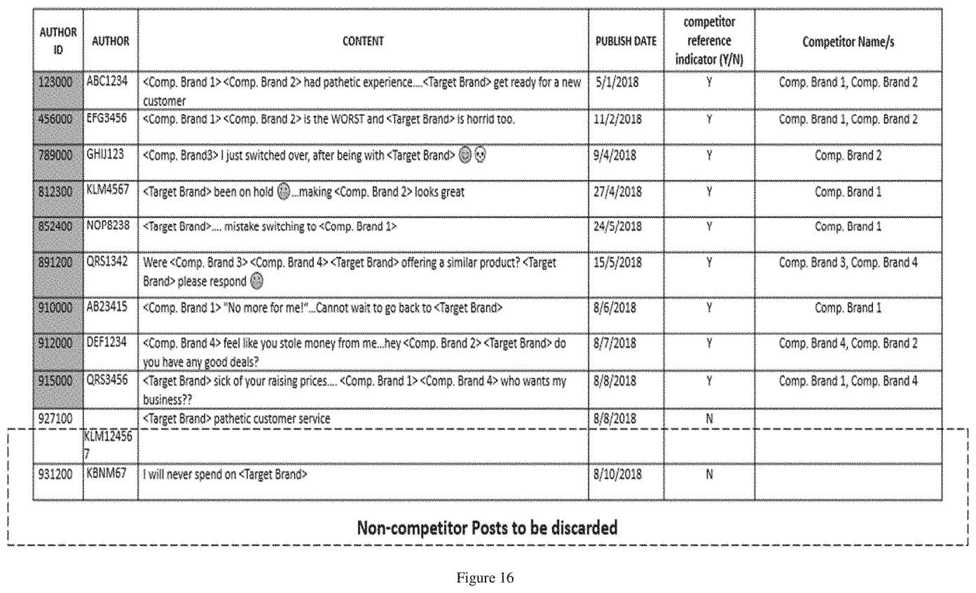

At step (302), identifying one or more texts from the plurality of texts including the one or more keywords. The one or more texts may comprise at least alphanumeric contents, and/or emoticons. The alphanumeric content may represent the words of the customer providing a review/feedback/opinion about a product/service offered by the at least one target entity or the at least one competitor entity. FIG. 16 illustrates an exemplary table of multi-competitor referenced texts identification and removal of non-competitor texts, in accordance with some embodiments of the present disclosure. The one or more texts with no competitor reference keywords will be discarded and the one or more texts with competitor reference keywords are considered. The one or more keywords include abbreviations, full names, short names, social handle names, one or more representatives of the at least one target entity and the at least one competitor entity. FIG. 14 illustrates an exemplary table of competitor entity lexicon data for competitors, in accordance with some embodiments of the present disclosure. For example, the company P-mobile is also referred as @Pmobile, @PMobileHelp, Pmobile, Pmodile, <P Mobile CEO Name>, Team Orange, PMob-Maybe and so on. Likewise. ZT&T is also referred as ZT&T, ZTT, @ZTT, ZTTCares, Ztnt, ZTTSupport, ZTTHelp. Further, competitor keywords may be stored in database (102) for further processing of texts and competitor keywords may be combined with competitor lexicon to generate target-entity specific comprehensive competitor lexicon.

FIG. 7 shows an exemplary competitor-referenced social text comprising multi-emotional icons. Emoticon (701) illustrates example of sentiment prediction of multi-emotional icons texts. Emoticon (702) represents thinking emotional icon with tonality score of −1 and sentiment assigned is negative, emoticon (703) represents warning emotional icon with tonality score of −1 and sentiment assigned is negative, emoticon (704) represents alert emotional icon with question mark emotional icon with tonality score of −1 and sentiment assigned is negative. Emoticon (705) represents pondering emotional icon with tonality score of −1 and sentiment assigned is negative and emoticon (706) represents check mark emotional icon with tonality score of +1 and sentiment assigned is positive. In this illustrative example, negative tonality score is −4 and positive tonality score is +1.0. Overall tonality score will be 0.60 and the determined sentiment for the multi-emoticon text is negative with reference to the threshold range.

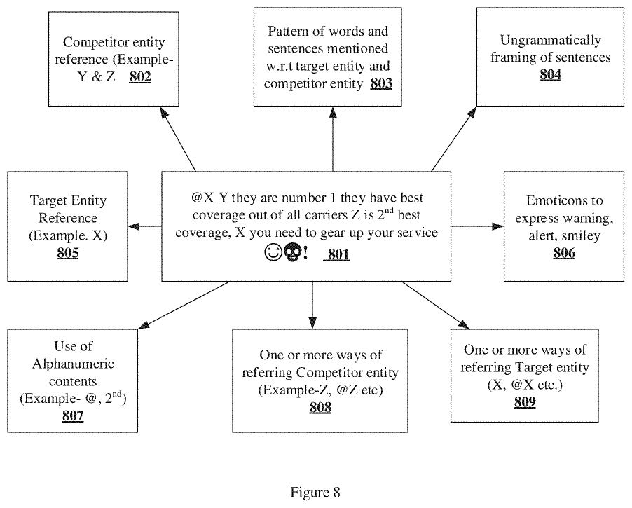

FIG. 8 shows exemplary competitor-referenced texts, in accordance with some embodiments of the present disclosure. FIG. 8 illustrates an exemplary competitor-referenced text. In example (801) “@X Y they are number 1 they have best coverage out of all carriers Z is 2^{nd} best coverage, X you need to gear up your service [symbol] ”. In the above example, “X” may be the target entity (805) and “Y” and “Z” herein may be the competitor entities (802) s. “X Y they are number 1 they have best coverage out of all carriers Z is 2^{nd} best coverage “depicts ungrammatically framing of sentences (804), “X Y they are number 1 they have best coverage out of all carriers Z is 2^{nd} best coverage “depicts a sentence commenting about the target entity and the competitor entities, X and @X depicts one or more ways of referring target entity (809), Z and @Z refers to one or more ways of referring competitor entity (808), @ and 2^{nd} are the alphanumeric contents (807), “@X Y they are number 1 they have best coverage out of all carriers Z is 2^{nd} best coverage” in the aforementioned sentence, target entity X is placed first and competitor entity Y and Z are positioned in the end. The emoticons/symbols “ [symbol] ” further asserts an emotion of the customer. In the above example, the emotion towards the competitor “Y” and “Z” are positive and the emotion towards the target entity “X” is negative. The present disclosure describes how the emotion towards a particular entity (for example the target entity) is determined in a text comprising multiple emotions towards multiple entities.

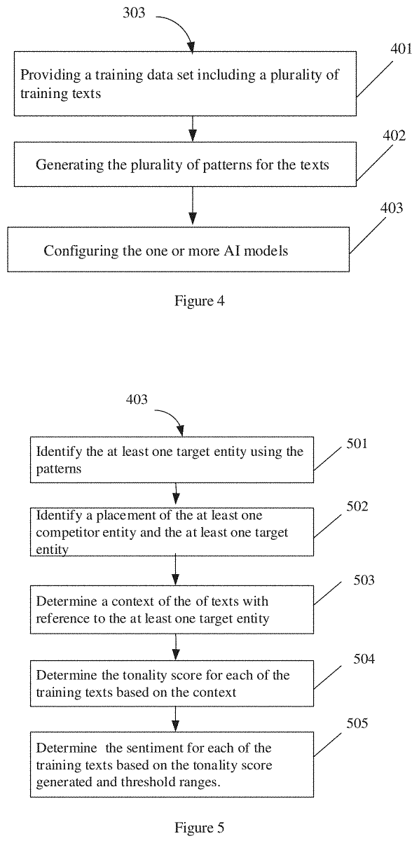

At step (303), determining a pattern from a plurality of patterns in the one or more texts using one or more Artificial Intelligence (AI) models. In an embodiment, the pattern includes one or more ways in which words are present in the one or more texts. The plurality of patterns of words may have a same or similar semantic meaning. For example, <Competitor Brand> . . . move over to <Target Brand>, <Competitor Brand> . . . left for <Target Brand>. Herein “move over to” and “left for” indicates the different patterns. In an embodiment, one or more AI models are trained to generate the tonality score based on the determined patterns. The one or more AI models may be supervised learning models like various regression models. In an embodiment, the various regression models may be a support vector regression (SVR), a linear SVR, a decision Tree regression, K-neighbors regression, Linear regression and the like. FIG. 4 shows a flowchart illustrating method steps for determining patterns in the one or more texts using the one or more Artificial Intelligence (AI) models, in accordance with some embodiments of the present disclosure. At step (401), providing a training data set including a plurality of training texts. The plurality of training texts is tagged with the sentiment. At step (402), generating the plurality of patterns for the one or more texts. The pattern includes the one or more words in the one or more texts. At step (403), configuring the one or more AI models. FIG. 5 shows a flowchart illustrating method steps for configuring one or more AI models, in accordance with some embodiments of the present disclosure. At step (501), the one or more AI models to identify the at least one target entity using the plurality of patterns. The one or more AI models may be supervised learning models like regression models. At step (502), identify a placement of the at least one competitor entity and the at least one target entity for each of the plurality of patterns. At step (503), determine a context of the plurality of texts with reference to the at least one target entity. At step (504), determine the tonality score for each of the plurality of training texts based on the context and finally at step (505), determine the sentiment for each of the training texts based on the tonality score generated and threshold ranges.

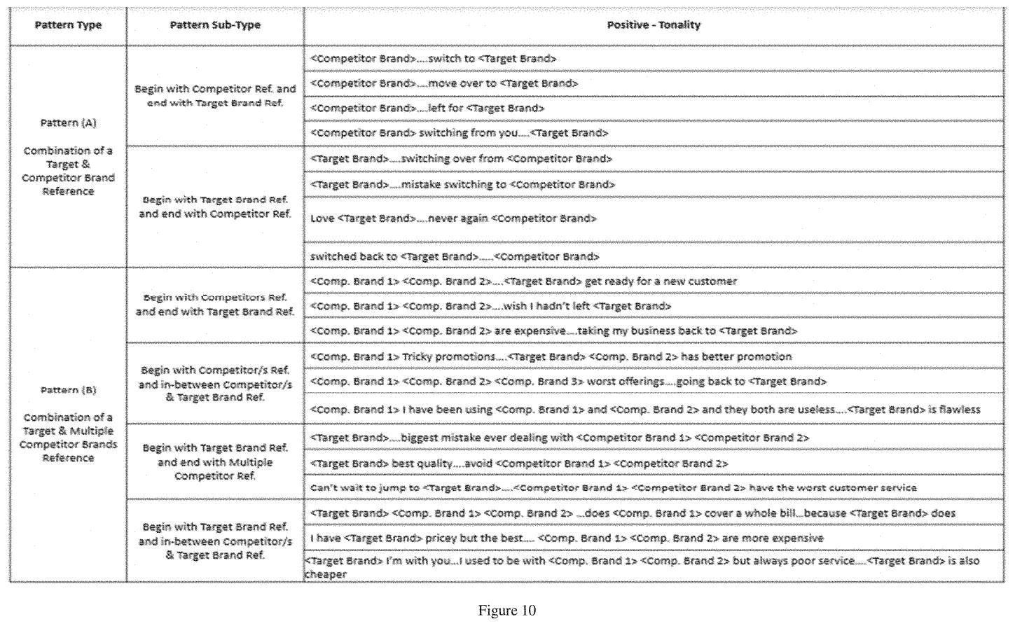

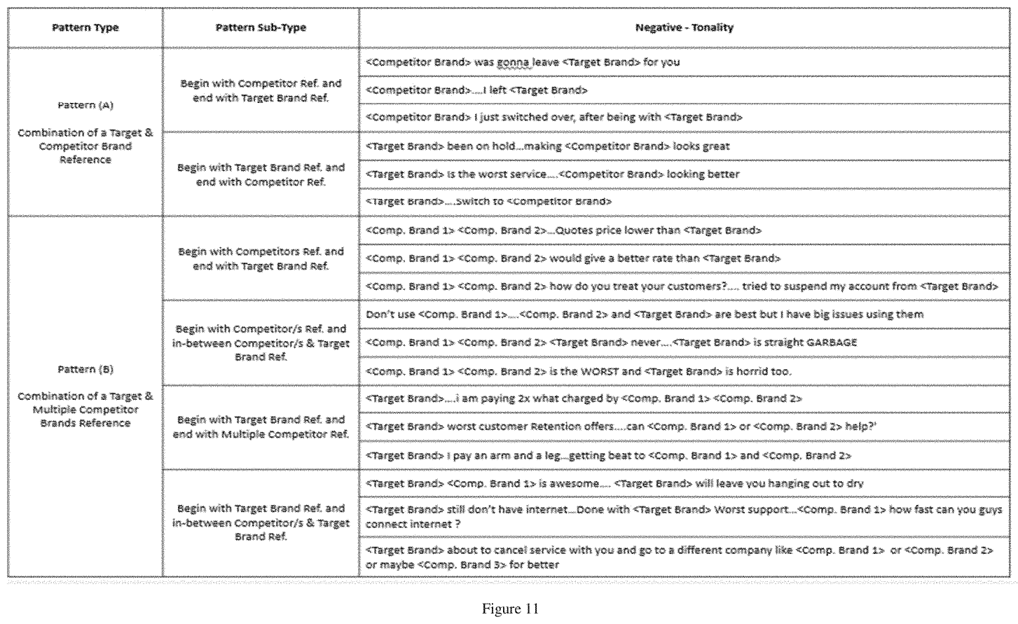

For example, as shown in FIG. 10 and FIG. 11 shows patterns and pattern sub-type. Herein, FIG. 10 illustrates a pattern lexicon for positive sentiment related texts, in accordance with some embodiments of the present disclosure, FIG. 11 illustrates a pattern lexicon for negative sentiment related texts, in accordance with some embodiments of the present disclosure. Pattern A is a combination of a target entity and competitor entity reference and pattern B is a combination of a target and multiple competitor entity reference. Pattern A comprises its sub-type patterns indicating the placement, like begin with competitor reference and end with target entity reference, begin with target entity reference and end with competitor reference. For example, <Competitor Brand> . . . move over to <Target Brand>, <Competitor Brand> . . . left for <Target Brand>. Herein “move over to” and “left for” indicates the different patterns. <Competitor Brand> and <Target Brand> indicates the placement as “begin with competitor reference and end with target entity reference”. The sentiment of both the texts are positive. Likewise, In the FIG. 11, the patterns and placement are indicated with respect to negative sentiment.

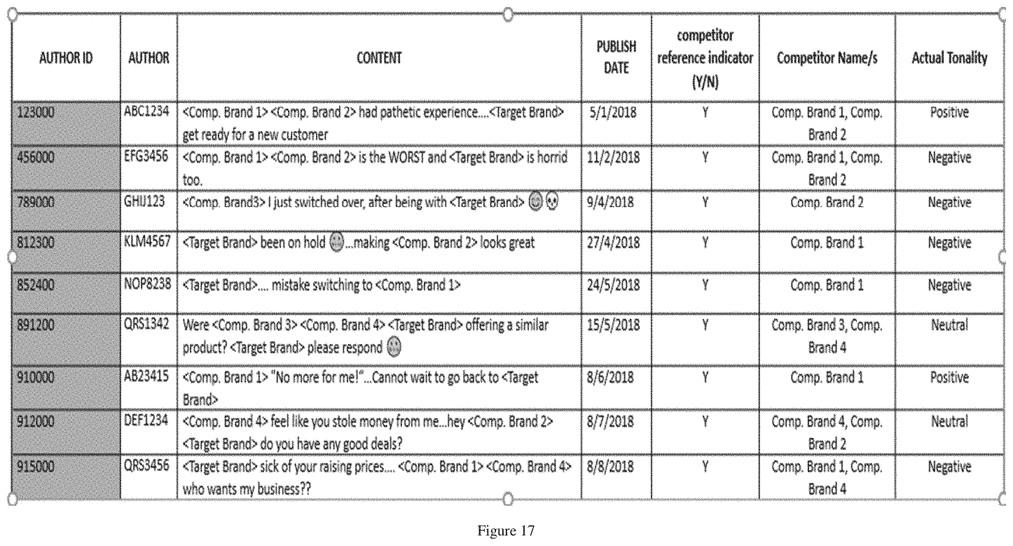

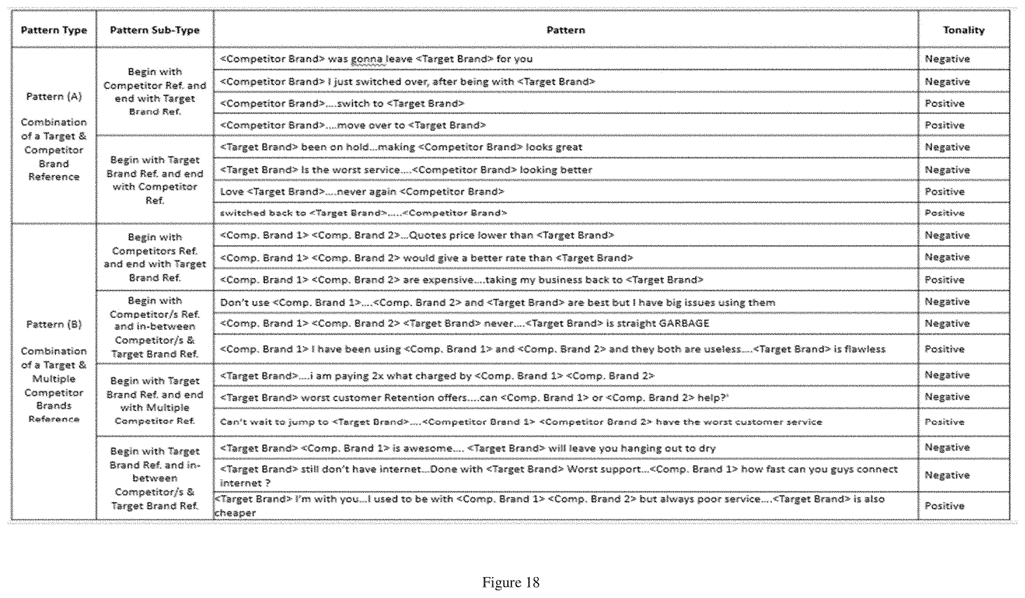

FIG. 17 illustrates an exemplary table of training data comprising labelled sentiment multi-competitor referenced texts, in accordance with some embodiments of the present disclosure. <Comp. Brand 1> <Comp. Brand 2> had pathetic experience . . . <Target Brand> get ready for a new customer. In the above example training text, “had pathetic experience”, “get ready for a new customer” are patterns with tagged sentiment as positive, with regard to target entity. In the next example, <Comp. Brand 1> <Comp. Brand 2> is the WORST and <Target Brand> is horrid too, herein “is the WORST” and “is horrid too” are the patterns depicting negative tonality towards target entity. Hence, the labelled sentiment is negative. In an embodiment, the sentiment may be negative, positive and neutral. FIG. 18 illustrates an exemplary table of training data comprising pattern taxonomy of competitor referenced texts, in accordance with some embodiments of the present disclosure. For example, “<Comp. Brand 1> <Comp. Brand 2> would give a better rate than <Target Brand>” is of pattern B with placement of target entity and competitor entity is begin with competitors reference and end with target entity reference and the tagged sentiment is negative.

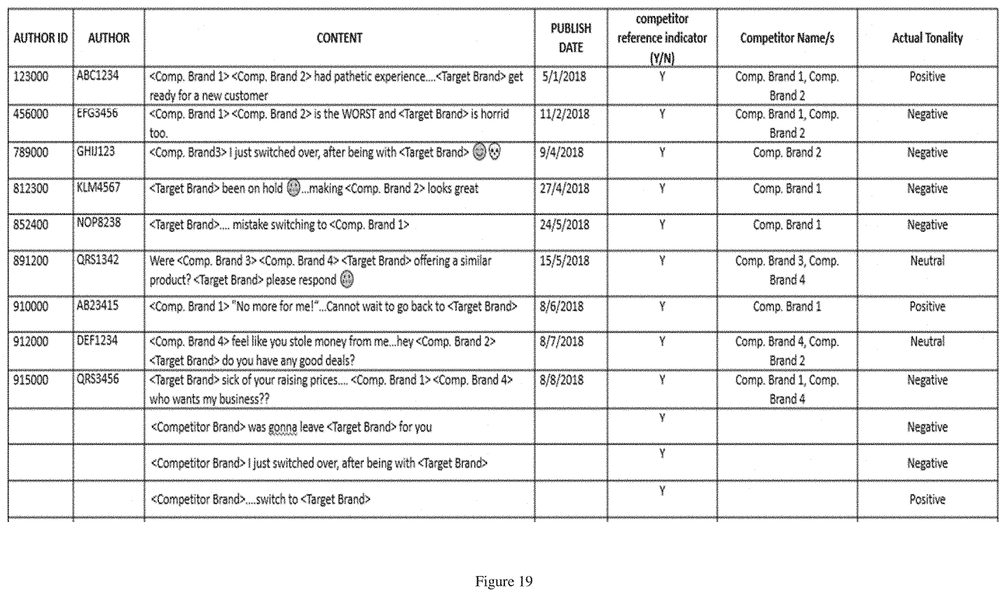

At step (304), identifying a placement of the at least one competitor entity and the at least one target entity in the one or more texts using the one or more AI models. FIG. 19 illustrates an exemplary table of training data with multi-competitor referenced texts tagged with sentiment based on placement identification and pattern detection, in accordance with some embodiments of the present disclosure. The placement of the at least one competitor entity and the at least one target entity is identified for each of the plurality of patterns. Consider the example from FIG. 19, “<Comp. Brand 1> <Comp. Brand 2> had pathetic experience . . . <Target Brand> get ready for a new customer”, “had pathetic experience and get ready for a new customer” are the patterns. The placement of competitor entity is at the beginning of the text and target entity placement is at the end. Based on these patterns the position of entities is determined and sentiment is tagged for each of the one or more texts.

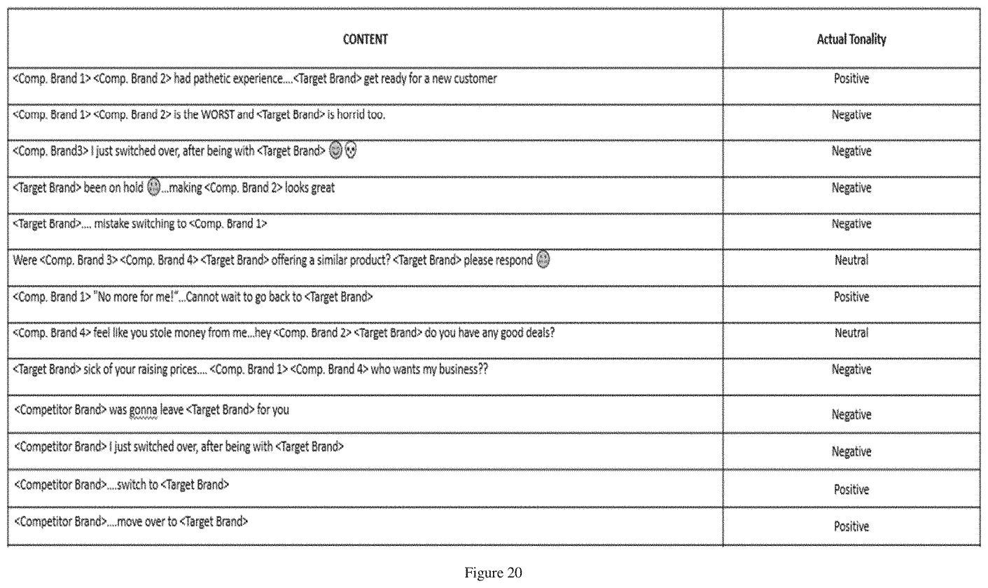

FIG. 20 illustrates an exemplary table of final training data comprising actual sentiment tagged texts based on the patterns and placements, in accordance with some embodiments of the present disclosure. The plurality of texts is tagged with sentiment based on the patterns and fed to the one or more AI models to determine the sentiment. For example, <Comp. Brand 1> <Comp. Brand 2> had pathetic experience . . . <Target Brand> get ready for a new customer, the sentiment based on alphanumeric content of the one or more texts is determined as positive as the sentiment is positive in view of target entity.

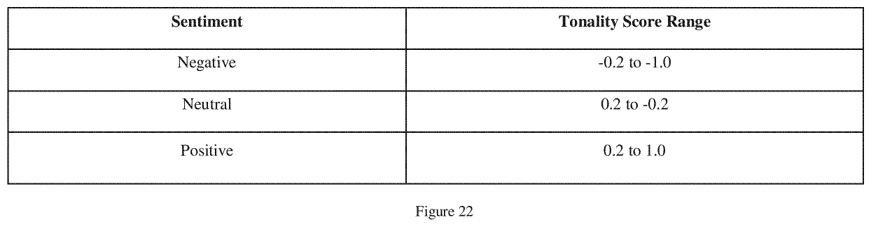

At step (305), determining for each of the one or more texts, a tonality score indicating a tone towards the at least one target entity based on the placement of the at least one target entity and the detected pattern of words present in the one or more texts. The one or more texts includes at least alphanumeric content and/or an emotional icon. The one or more threshold ranges are defined for the alphanumeric content-based tonality score, and a threshold range is defined for the emotional icons-based tonality score. FIG. 22 depicts an exemplary table of sentiment and tonality score threshold range, in accordance with some embodiments of the present disclosure. For example, for negative sentiment, the tonality score range is between −0.2 and −1.0, for neutral sentiment the tonality score range is between 0.2 and −0.2 and for the positive sentiment the tonality score range is between 0.2 and 1.0. The one or more texts are trained by tagging tonality score for each of the texts in the plurality of texts. The one or more AI models are trained using various regression models considering continuous range of +1 and −1, +1 may be considered as strong positive sentiment, −1 may be considered as strong negative sentiment, 0 may be considered as strong neutral sentiment while training the texts using AI models to determine the sentiment using the tonality score of the one or more texts.

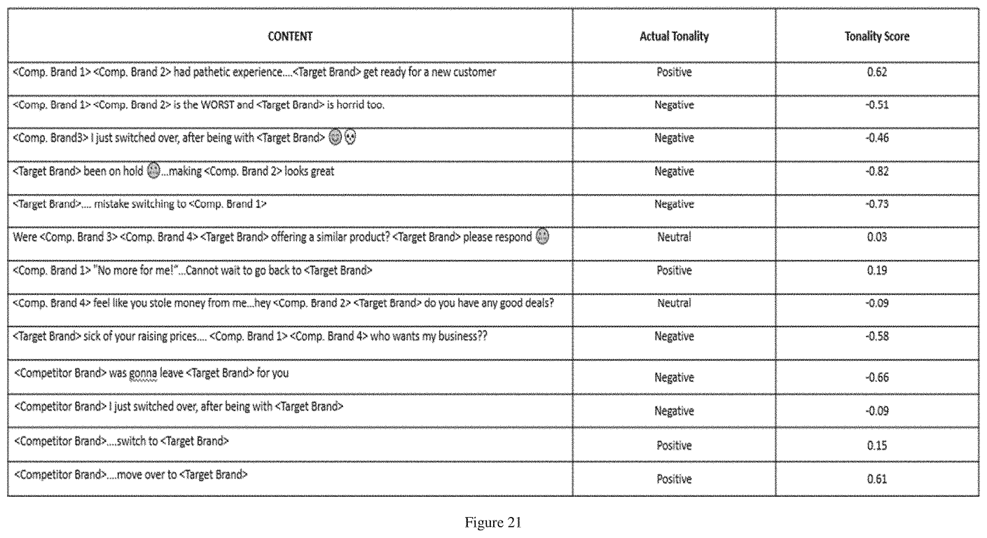

FIG. 21 illustrates an exemplary table of tonality score assignment for competitor referenced texts, in accordance with some embodiments of the present disclosure. The Table consists of content or text, actual tonality which is also referred as tagged sentiment and the tonality score for each of the one or more texts is determined based on the placement and the pattern of the text. For example, “<Comp. Brand 1> <Comp. Brand 2> had pathetic experience . . . <Target Brand> get ready for a new customer”. Since the positive sentiment the tonality score range is fixed between 0.2 and 1.0 as illustrated in FIG. 22 and the determined tonality score is 0.62 with the sentiment as positive.

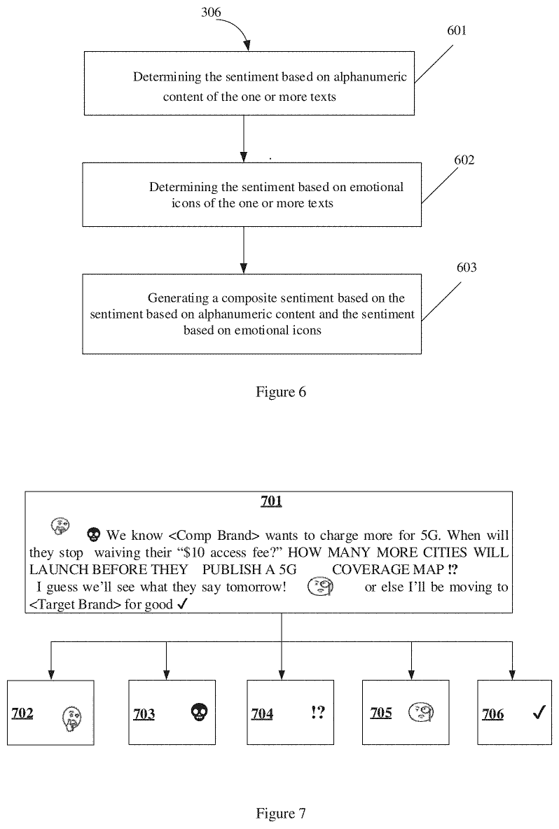

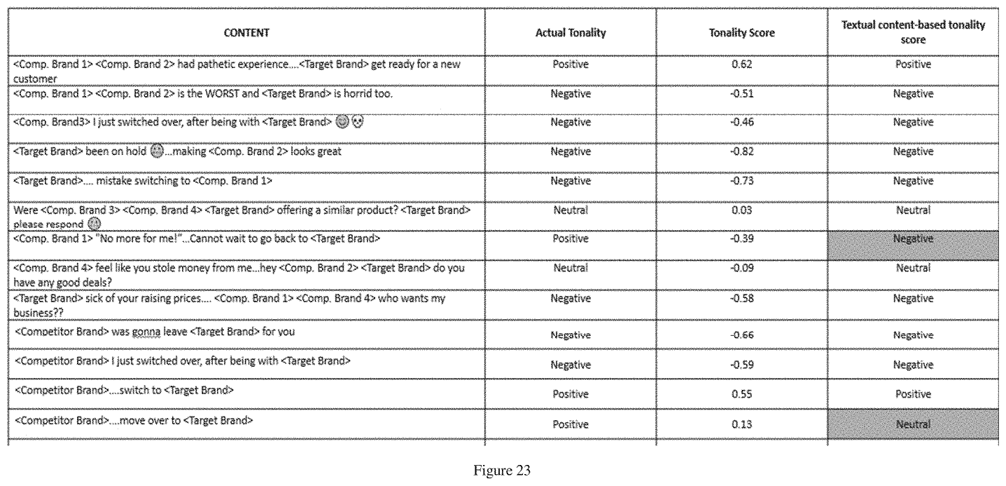

At step (306), determining a sentiment for each of the one or more texts based on the tonality score. FIG. 6 shows a flowchart illustrating method steps for determining a sentiment for texts based on the tonality score, in accordance with some embodiments of the present disclosure at step (601), determining the sentiment based on alphanumeric content of the one or more texts. Determining the sentiment for each of the plurality of training texts based on the tonality score generated and one or more threshold ranges. Likewise, one or more threshold ranges are defined for the tonality score of the alphanumeric content. The sentiment for an input text is determined by comparing the determined tonality score of the text with the one or more threshold ranges. The composite sentiment is calculated using the sentiment determined for the alphanumeric content and the sentiment of the emoticons. The one or more AI models are tuned, wherein tuning comprises comparing the sentiment determined by the one or more AI models with the sentiment tagged to the plurality of training texts. Determining the sentiment for the emotional icons comprises generating the tonality score for the emotional icon. Further, determining a maximum value of the tonality score and determining the sentiment based on the maximum value of the tonality score and the threshold range. The sentiment tagged with the plurality of training texts comprises the sentiment based on alphanumeric content and the sentiment based on emotional icons. A feedback is provided to the one or more AI models based on the comparing. For the exceptional texts as highlighted in the FIG. 23, “<Comp. Brand 1>“No more for me!” . . . Cannot wait to go back to <Target Brand>”. The actual tonality is positive but determined sentiment for alphanumeric content using one or more AI models is negative which is contradictory. Further, these texts are fed to the one or more AI models through feedback for training. Upon training these texts, the accurate sentiment is determined for the texts. In an embodiment, the trained AI models may be tested using testing data, which are different from the training data. Based on an outcome of the AI models, further feedback may be provided to finetune model parameters.

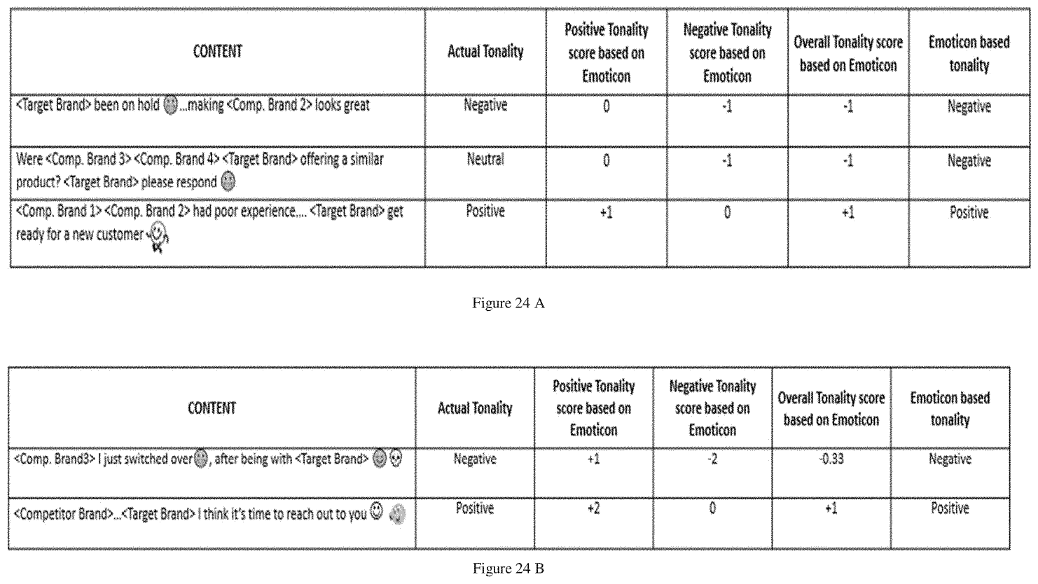

FIG. 23 illustrates an exemplary table of a sentiment output determined by chosen AI model for alphanumeric content, in accordance with some embodiments of the present disclosure. For example, “<Comp. Brand 1> <Comp. Brand 2> had pathetic experience . . . <Target Brand> get ready for a new customer”. The sentiment determined by the one or more AI models with the sentiment tagged to the plurality of training texts is positive (actual tonality), the determined sentiment for alphanumeric content using one or more AI models is positive score based on the tonality score 0.62. At step (602), determining the sentiment based on emotional icons of the one or more texts. FIG. 24A illustrates an exemplary table of sentiment output determined for competitor-referenced texts comprising single-emoticon. FIG. 24B illustrates an exemplary table of sentiment output determined for competitor-referenced texts comprising multi-emoticons, in accordance with some embodiments of the present disclosure. Identifying and tagging texts comprising single-emoticon or multi-emoticons using the regex algorithm for pattern matching. Single-emoticon texts are the texts consisting of just one emoticon. Multi-emoticon texts are the texts consisting of two or more emoticons. For single emoticon texts, tonality scores may be calculated for positive, negative, and neutral sentiments, based on the extent of match against emoticon lexicon which comprises the sentiment groups like positive emotional icons, negative emotional icons and neutral emotional icons. In an embodiment, the emoticons are also referred as emotional icon. For multi emoticon texts, various emoticons will be extracted. Individual emoticon will be analyzed using regex algorithm for pattern matching. The sentiment is determined based on the overall tonality score with reference to the threshold range. The regex algorithm used for pattern matching and determining the sentiment of emotional icons may be regular expression (regex) models against various patterns in the emoticon lexicon. The regex models may be a backtracking algorithm and the like. For example, in the FIG. 24A “<Target Brand> been on hold [symbol] . . . making <Comp. Brand 2> looks great”, consists of single emoticon with negative emoticon sentiment (actual tonality), as the emoticon is included in the negative emoticon group of emoticon lexicon and the determined with overall tonality score is −1 of negative sentiment. Since the negative tonality score based on emoticon has maximum tonality score than positive tonality score based on emoticon, the, −1 negative tonality score is considered as the overall tonality score and the determined sentiment for the emoticon is negative.

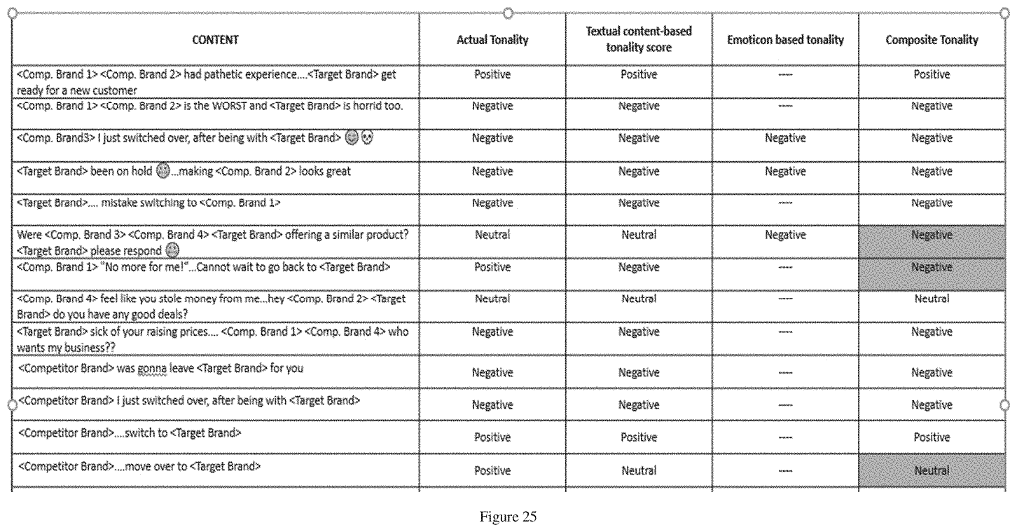

At step (603), generating a composite sentiment based on the sentiment based on alphanumeric content and the sentiment based on emotional icons. The composite sentiment determines the sentiment of the one or more texts. The sentiment is one of, a negative sentiment, a positive sentiment, and a neutral sentiment. The sentiment based on alphanumeric content has higher priority over the sentiment of the emotional icons sentiment and the sentiment based on emotional icons has higher priority over the sentiment based on alphanumeric content when the sentiment based on alphanumeric content is a neutral sentiment. FIG. 25 illustrates an exemplary table of sentiment output for competitor-referenced texts having emoticons and alphanumeric content, in accordance with some embodiments of the present disclosure. For example, “Competitor Brand> [symbol] . . . <Target Brand> I think it's time to reach out to you [symbol] ”, herein the tagged sentiment (actual sentiment) is positive, alphanumeric content sentiment is positive, the emoticon-based sentiment is negative. Since alphanumeric content has higher priority over the sentiment of the emotional icon's sentiment. Thus, the composite sentiment is determined as positive.

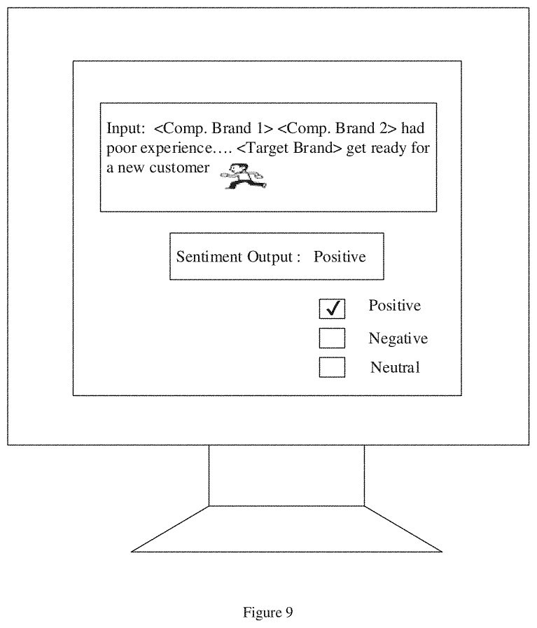

At step (307), notifying the sentiment towards the at least one target entity on a notification unit. FIG. 9 illustrates an exemplary notification unit for notifying the sentiment, in accordance with some embodiments of the present disclosure. In an embodiment, notification unit may be a computer system, a mobile unit, a user interface, a business application, and the like. When the user enters the input text to the system may display sentiment output as at least one of negative, positive or neutral. In an embodiment, the sentiment with tonality score may also be displayed. For example, Input is given as “<Comp. Brand 1> <Comp. Brand 2> had poor experience . . . <Target Brand> get ready for a new customer “. The system determines the sentiment output using the one or more AI models and displays the sentiment output as “Positive” to the specific target entity. If the sentiment output is negative, the alert submodule in the notification unit may send an alert message to the business teams.

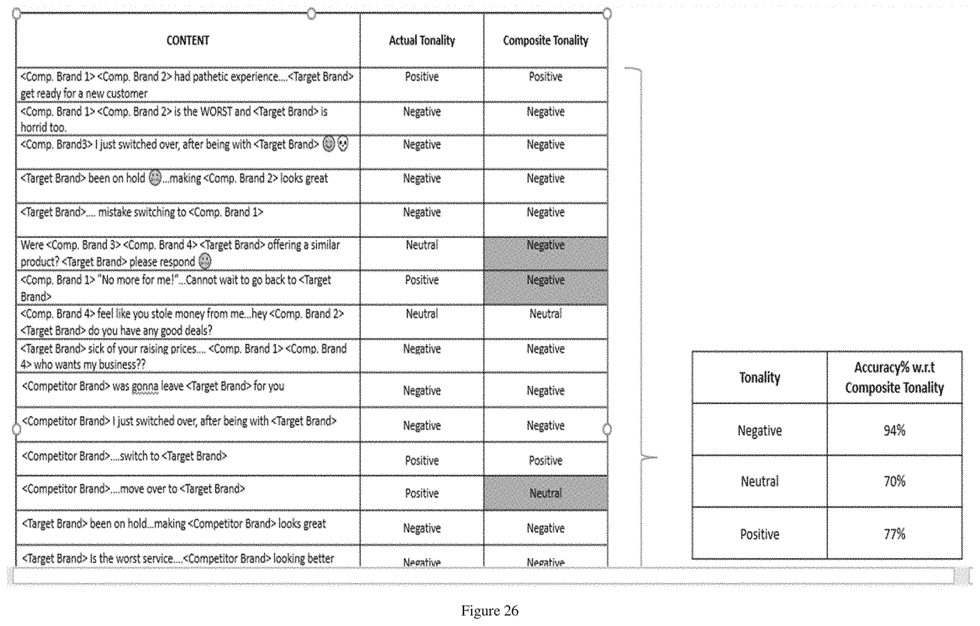

FIG. 26 illustrates an exemplary table of accuracy assessment for overall sentiment of competitor-referenced texts, in accordance with some embodiments of the present disclosure The one or more AI models may undergo first-level accuracy assessment by comparing composite sentiment output with actual tagged sentiment. Accuracy assessment includes calculating accuracy for individual sentiment. Accuracy for negative sentiment, positive sentiment and for neutral sentiment. Under final accuracy assessment of contextual sentiment prediction engine, target brand specific new incremental texts data will be extracted from database for unstructured content and processed data. Target entity specific new incremental texts data is an exclusive data set which was not considered as training data. Actual tonality is pre-tagged for individual new incremental texts. Sentiment for each of the new texts may be determined based on the one or more AI models. Determined sentiments may be compared with respective actual tonalities and accuracy will be assessed with respect to negative, positive, and neutral sentiments. In case of accuracy for individual sentiment is more than or equal to pre-defined value, the training data needs to be fine-tuned and development steps will be reiterated.

The present disclosure provides the accurate and efficient method and system to determine contextual sentiment for competitor referenced texts.

The present disclosure helps in identifying users/customers with positive reviews towards the target entity and helps in providing customized solutions to those users/customers.

The present disclosure provides the system to identify cluster of unhappy existing customers and alert respective sales teams to avoid possible customer base erosion.

The present disclosure provides the system to identify new leads expressing negative sentiments towards competitors. New leads could be considered for customer acquisition strategies.

### Computer System

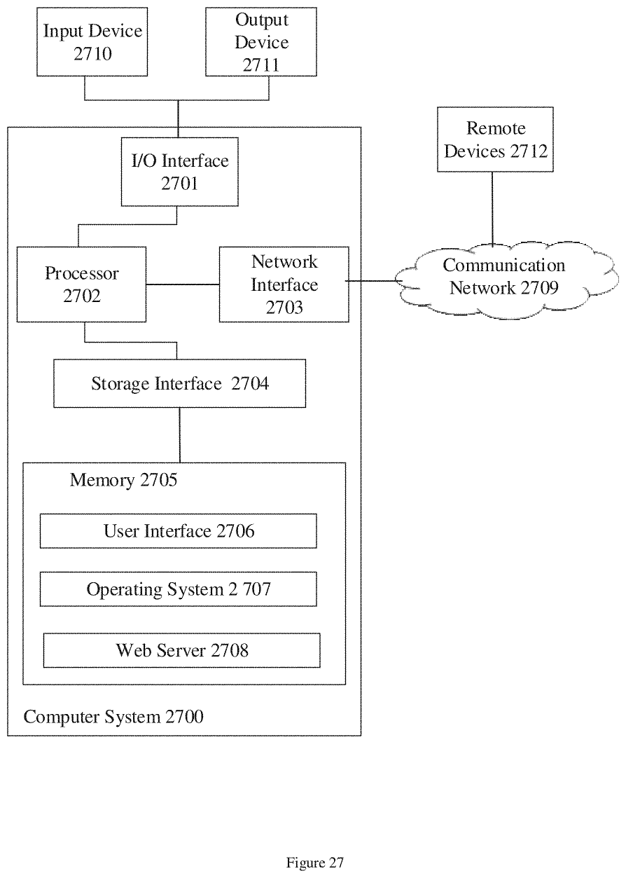

FIG. 27 depicts a block diagram of a general-purpose computer capable of contextual sentiment analysis of competitor referenced texts, in accordance with an embodiment of the present disclosure. In an embodiment, the computer system (2700) is used to implement generation of sentiment-based summary for user reviews. The computer system (2700) may comprise a central processing unit (“CPU” or “processor”) (2702). The processor (2702) may comprise at least one data processor. The processor (2702) may include specialized processing units such as integrated system (bus) controllers, memory management control units, floating point units, graphics processing units, digital signal processing units, etc.

The processor (2702) may be disposed in communication with one or more input/output (I/O) devices (not shown) via I/O interface (2701). The I/O interface (2701) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (2701), the computer system (2700) may communicate with one or more I/O devices. For example, the input device (2710) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (2711) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (2700) is connected to the remote devices (2712) through a communication network (2709). The remote devices (2712) may provide the user reviews to the computing network (2700). The processor (2702) may be disposed in communication with the communication network (2709) via a network interface (2703). The network interface (2703) may communicate with the communication network (2709). The network interface (2703) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (2709) may include, without limitation, a direct interconnection, local area network (LAN), wide area network (WAN), wireless network (e.g., using Wireless Application Protocol), the Internet, etc. Using the network interface (2703) and the communication network (2709), the computer system (2700) may communicate with the scene remote devices (2712). The network interface (2703) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network (2709) includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor (2702) may be disposed in communication with a memory (27027) (e.g., RAM, ROM, etc. not shown in FIG. 27) via a storage interface (2704). The storage interface (2704) may connect to memory (27027) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (27027) may store a collection of program or database components, including, without limitation, user interface (2706), an operating system (27027), web server (2708) etc. In some embodiments, computer system (2700) may store user/application data, such as, the data, variables, records, etc., as described in this disclosure. Such databases may be implemented as fault-tolerant, relational, scalable, secure databases such as Oracle® or Sybase®.

The operating system (27027) may facilitate resource management and operation of the computer system (2700). Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/27/8, 10 etc.), APPLE® IOS™ GOOGLE® ANDROID™, BLACKBERRY® OS, or the like.

In some embodiments, the computer system (2700) may implement a web browser (2708) stored program component. The web browser (2708) may be a hypertext viewing application, for example MICROSOFT® INTERNET EXPLORER™, GOOGLE® CHROME™⁰, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (2708) may utilize facilities such as AJAX™, DHTML™ ADOBE® FLASH™, JAVASCRIPT™, JAVA™, Application Programming Interfaces (APIs), etc. In some embodiments, the computer system (2700) may implement a mail server stored program component. The mail server may be an Internet mail server such as Microsoft Exchange, or the like. The mail server may utilize facilities such as ASP™, ACTIVEX™, ANSI™ C++/C #, MICROSOFT®, .NET™, CGI SCRIPTS™, JAVA™, JAVASCRIPT™, PERL™, PHP™ PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system (2700) may implement a mail client stored program component. The mail client may be a mail viewing application, such as APPLE® MAIL™ MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices, which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is, therefore, intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope being indicated by the claims.

We claim:

1. A method for contextual sentiment analysis of competitor referenced texts, the method comprising:
obtaining, by a system, a plurality of texts and a lexicon comprising one or more keywords indicating at least one competitor entity and at least one target entity;
identifying, by the system, one or more texts from the plurality of texts including the one or more keywords;
determining, by the system, a pattern from a plurality of patterns in the one or more texts using one or more Artificial Intelligence (AI) models, wherein the pattern includes one or more words in the one or more texts;
identifying, by the system, a placement of the at least one competitor entity and the at least one target entity in the one or more texts using the one or more AI models;
determining, by the system, for each of the one or more texts, a tonality score indicating a tone towards the at least one target entity based on the placement of the at least one target entity and the pattern;
determining, by the system, a sentiment for each of the one or more texts based on the tonality score; and
notifying, by the system, the sentiment towards the at least one target entity on a notification unit.

2. The method as claimed in claim 1, wherein the one or more keywords include abbreviations, full names, short names, social handle names, one or more representatives of the at least one target entity and the at least one competitor entity.

3. The method as claimed in claim 1, wherein the one or more texts includes at least alphanumeric content and/or an emotional icon.

4. The method as claimed in claim 1, wherein the sentiment is one of, a negative sentiment, a positive sentiment, and a neutral sentiment.

5. The method as claimed in claim 1, wherein determining the sentiment of the one or more texts comprises:
determining the sentiment based on alphanumeric content of the one or more texts;
determining the sentiment based on emotional icons of the one or more texts; and
generating a composite sentiment based on the sentiment based on alphanumeric content and the sentiment based on emotional icons, wherein the composite sentiment determines the sentiment of the one or more texts.

6. The method as claimed in claim 5, wherein the sentiment based on alphanumeric content has higher priority over the sentiment of the emotional icons sentiment; and
wherein the sentiment based on emotional icons has higher priority over the sentiment based on alphanumeric content when the sentiment based on alphanumeric content is a neutral sentiment.

7. The method as claimed in claim 1, wherein one or more AI models are trained to determine the tonality score, wherein training the one or more AI models comprises:
providing a training data set including a plurality of training texts, wherein each of the plurality of training texts is tagged with the sentiment;
generating the plurality of patterns for the one or more texts, wherein the pattern includes one or more words in the one or more texts;
configuring the one or more AI models to:
identifying the at least one target entity using the plurality of patterns;
for each of the plurality of patterns, identify a placement of the at least one competitor entity and the at least one target entity;
determining a context of the plurality of texts with reference to the at least one target entity;
generating the tonality score for each of the plurality of training texts based on the context; and
determining the sentiment for each of the plurality of training texts based on the tonality score generated and one or more threshold ranges.

8. The method as claimed in claim 6, wherein the one or more AI models are tuned, wherein tuning comprises:
comparing the sentiment determined by the one or more AI models with the sentiment tagged to the plurality of training texts; and
providing a feedback to the one or more AI models based on the comparing.

9. The method as claimed in claim 6, wherein the one or more threshold ranges are defined for the alphanumeric content-based tonality score, and a threshold range is defined for the emotional icons-based tonality score.

10. The method as claimed in claim 6, wherein determining the sentiment for the emotional icons comprises:
generating the tonality score for the emotional icon;
determining a maximum value of the tonality score; and
determining the sentiment based on the maximum value of the tonality score and the threshold range.

11. The method as claimed in claim 6, wherein the sentiment tagged with the plurality of training texts comprises the sentiment based on alphanumeric content and the sentiment based on emotional icons.

12. A system for contextual sentiment analysis of competitor referenced texts, the system comprising a processor and a memory comprising programmed instructions stored in the memory, wherein the processor is configured to execute the programmed instructions stored in the memory to:
obtain a plurality of texts and a lexicon comprising one or more keywords indicating at least one competitor entity and at least one target entity;
identify one or more texts from the plurality of texts including the one or more keywords;
determine a pattern from a plurality of patterns in the one or more texts using one or more Artificial Intelligence (AI) models, wherein the pattern includes one or more words in the one or more texts;
identify a placement of the at least one competitor entity and the at least one target entity in the one or more texts using the one or more AI models;
determine for each of the one or more texts, a tonality score indicating a tone towards the at least one target entity based on the placement of the at least one target entity and the pattern;
determine a sentiment for each of the one or more texts based on the tonality score; and
notify the sentiment towards the at least one target entity on a notification unit.

13. The system as claimed in claim 12, wherein the one or more keywords include abbreviations, full names, short names, social handle names, one or more representatives of the at least one target entity and the at least one competitor entity.

14. The system as claimed in claim 12, wherein the one or more texts includes at least alphanumeric content and/or an emotional icon.

15. The system as claimed in claim 12, wherein the sentiment is one of, a negative sentiment, a positive sentiment, and a neutral sentiment.

16. The system as claimed in claim 12, wherein the one or more processors are configured to determine the sentiment of the one or more texts, wherein the one or more processors are configured to:
determine the sentiment based on alphanumeric content of the one or more texts;
determine the sentiment based on emotional icons of the one or more texts; and
generate a composite sentiment based on the sentiment of the alphanumeric content and the sentiment based on emotional icons, wherein the composite sentiment determines the sentiment of the one or more texts.

17. The system as claimed in claim 16, wherein the sentiment based on alphanumeric content has higher priority over the sentiment based on emotional icons when the sentiment of the emotional icons is a neutral sentiment; and
wherein the sentiment based on emotional icons have higher priority over the sentiment based on alphanumeric content when the sentiment based on alphanumeric content is a neutral sentiment.

18. The system as claimed in claim 11, wherein the one or more processors are configured to determine the tonality score, wherein training the one or more AI models are configured to:
provide a training data set including a plurality of training texts, wherein each of the plurality of training texts is tagged with the sentiment;
generate the plurality of patterns for the one or more texts, wherein the pattern includes one or more words in the one or more texts; and
configure the one or more AI models to:
identify the at least one target entity using the plurality of patterns;
for each of the plurality of patterns, identify a placement of the at least one competitor entity and the at least one target entity;
determine a context of the plurality of texts with reference to the at least one target entity;
determine the tonality score for each of the plurality of training texts based on the context; and
determine the sentiment for each of the plurality of training texts based on the tonality score generated and one or more threshold ranges.

19. The system as claimed in claim 18, wherein the one or more processors are configured to tune the one or more AI models are tuned, wherein the one or more processors are configured to:
compare the sentiment determined by the one or more AI models with the sentiment tagged to the plurality of training texts; and
provide a feedback to the one or more AI models based on the comparing.

20. The system as claimed in claim 18, wherein the one or more threshold ranges are defined for the alphanumeric content-based tonality score, and a threshold range is defined for the emotional icons-based tonality score.

21. The system as claimed in claim 18, wherein the one or more processors are configured to determine the sentiment based on emotional icons, wherein the one or more processors are configured to:
determine the tonality score for the emotional icon;
determine a maximum value of the tonality score; and
determine the sentiment based on the maximum value of the tonality score and the threshold range.

22. The system as claimed in claim 18, wherein the sentiment tagged with the plurality of training texts comprises the sentiment based on alphanumeric content and the sentiment based on emotional icons.

23. A non-transitory computer readable medium for contextual sentiment analysis of competitor referenced texts, having stored thereon, one or more instructions that when processed by at least one processor cause a device to perform operations comprising:
obtaining a plurality of texts and a lexicon comprising one or more keywords indicating at least one competitor entity and at least one target entity;
identifying one or more texts from the plurality of texts including the one or more keywords;
determining a pattern from a plurality of patterns in the one or more texts using one or more Artificial Intelligence (AI) models, wherein the pattern includes one or more words in the one or more texts;
identifying a placement of the at least one competitor entity and the at least one target entity in the one or more texts using the one or more AI models;
determining for each of the one or more texts, a tonality score indicating a tone towards the at least one target entity based on the placement of the at least one target entity and the pattern;
determining a sentiment for each of the one or more texts based on the tonality score; and
notifying the sentiment towards the at least one target entity on a notification unit.
